(19) United States
(12) Patent Application Publication
(10) Pub. No.: US 2026/0250793 A1
(43) Pub. Date: Aug. 27, 2026

(54) H2 RICH GAS INJECTION TO DIRECT REDUCTION SHAFT FURNACE UPPER SECTION

(71) Applicant: Midrex Technologies, Inc., Charlotte, NC (US)

(72) Inventor: Haruyasu Michishita, Charlotte, NC (US)

(21) Appl. No.: 19/435,990

(22) Filed: Dec. 30, 2025

Related U.S. Application Data
(60) Provisional application No. 63/762,145, filed on Feb. 24, 2025.

(51) Int. Cl. C21B 13/00; C21B 13/02

(52) U.S. Cl. CPC C21B 13/0073; C21B 13/029; C21B 2100/22; C21B 2100/60

(57) ABSTRACT

A method of direct reduction of iron oxide includes receiving an iron oxide, injecting a reduction gas into the shaft furnace through a bustle gas port, and removing a top gas from a top gas offtake located above the bustle gas port. The method also includes injecting hydrogen rich gas to the shaft furnace through a upper reduction gas port positioned above the bustle gas port and below the top gas offtake such that a reduction speed and a reduction temperature within an upper section of the shaft furnace is moderated to prevent swelling and disintegration of the iron oxide utilizing more endothermic reaction between iron oxide and H2 in comparison with a reduction gas including CO, maintaining the higher reduction temperature underneath.

### CROSS-REFERENCE TO RELATED APPLICATION

The present disclosure claims the benefit of priority of co-pending U.S. Provisional Patent Application No. 63/762,145, filed on Feb. 24, 2025, and entitled “H2 RICH GAS INJECTION TO DIRECT REDUCTION SHAFT FURNACE UPPER SECTION,” the contents of which are incorporated in full by reference herein.

### TECHNICAL FIELD

The present disclosure relates generally to direct reduced iron (DRI) production and steelmaking fields. More specifically, the present disclosure relates to a direct reduction (DR) system and method to mitigate the clustering or disintegration of iron oxide, such as pellet, lump, or cold agglomerate (CA or CBQ), during a reduction reaction.

### BACKGROUND

According to a series of laboratory tests and observations of DR plant operations, the higher the initial reduction temperature is and/or the higher the initial reduction speed is, the more the iron oxide swells at the initial reduction stage or the reduction degree up to 10~30%. The swelling by the lattice structure changes from Fe2O3 to Fe3O4 or FeO happening at the upper section in the shaft furnace (SF) reduces the physical strength of the iron oxide, which enhances later disintegration through the movements in the moving bed. The reduced physical strength somewhat recovers later as the formation of the metallic iron progresses to sinter and shrink the material, but the strength recovery cannot make up the earlier strength reduction if the swelling exceeds the recovery. Also, more rapid and more significant swelling sometimes enhances the clustering of the material in the SF since the swelling helps the material to deform in a flat shape and increases the contact area under the burden load in SF. The larger contact area for the deformed iron oxide facilitates the material to stick together and make clusters. Also, the fines generated from the disintegration can also help to make clusters since the fines can bridge the iron oxide.

This is the issue especially with CBQ bonded with conventional binders since it cannot maintain the physical strength at the initial reduction temperature, typically 400~700° C. in the SF. CBQ tends to disintegrate or make clusters since the bonding strength by the binder is lost when it swells or before the sintering of metallic iron starts in the temperature range. Therefore, the swelling with CBQ can be restrained if the temperature is maintained low enough for the binder to keep the bonding strength until the swelling declines or the metallic iron formation starts. This enables the prevention of the disintegration or clustering in the SF.

As such, a need exists in the art for a DRI system and associated process that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a DRI system and associated process that overcome the limitations of the known art. Embodiments of the present disclosure improve upon prior systems and methods to produce DRI in a SF utilizing natural gas (NG) and/or hydrogen (H2) and mitigate the disintegration and clustering of the iron oxide during the reduction reaction in the SF.

The swelling and initial reduction speed from Fe2O3 to Fe3O4 or FeO, which influences the disintegration and clustering tendency, is restrained by modulating (or moderating) the temperature in the upper section of the SF. More specifically, this is achieved by injecting H2 or H2 rich gas above the main reduction bustle gas ports. Injecting H2 or H2 rich gas above the main reduction bustle gas ports lowers the bed temperature due to the significantly more endothermic reaction between iron oxide and H2 in comparison with a main reduction gas including CO or an H2/CO mixture.

Furthermore and in some configurations, hydrogen makeup gas provided separately may flexibly replace a part of NG or hydrogen/carbon monoxide reformed from NG to reduce the carbon dioxide emission from the direct reduction plant, depending on hydrogen availability. Such hydrogen gas may include 90% or more hydrogen gas, at least in some embodiments.

Simultaneously, as an option, the length of the reduction zone, defined as the distance between the reducing gas port and a controlled feed stock line, can be extended, to compensate for the productivity drop caused by the lower temperature in the upper section of the SF. For example and in some embodiments, a convention length of the reduction zone of a typical SF (e.g., approximately 9-13 meters depending on the diameter) may be extended by approximately 1-3 meters.

To achieve the foregoing and other objects and advantages, in one aspect, the present subject matter is directed to a method of direct reduction of iron oxide including charging an iron oxide at a top of a shaft furnace. The method further includes reforming natural gas with a reformer to produce H2 and CO in a reduction gas to reduce the iron oxide in the shaft furnace. The method also includes injecting the reduction gas into the shaft furnace through a bustle gas port. The method additionally includes removing a top gas from a top gas offtake located above the bustle gas port. Another element of the method includes processing a portion of the top gas in a hydrogen recovery system to form a hydrogen rich gas and a hydrogen lean gas. The method further includes injecting the hydrogen rich gas to the shaft furnace through a hydrogen rich gas port located above the bustle gas port and below the top gas offtake such that a reduction speed and a reduction temperature in an upper section of the shaft furnace is moderated.

In at least one embodiment, the method may include adjusting a flow rate of the hydrogen rich gas injected into the shaft furnace utilizing a valve and a control unit and based on at least a temperature of the top gas. Additionally or alternatively, the hydrogen rich gas port may be located at a level higher than ⅔ of a reduction zone height or higher than 6 m above a reduction gas injection line. In some such embodiments or other embodiments, the reduction zone may be defined as a burden zone between the reduction gas injection level and a controlled feed stock line in the shaft furnace. Additionally or alternatively, the method may include combusting a mixture of the hydrogen lean gas and another portion of the top gas utilizing a reformer burner of a reformer.

In an additional or alternative aspect, the present subject matter is directed to a method of direct reduction of iron oxide including charging an iron oxide at a top of a shaft furnace. The method further includes reforming natural gas with a reformer to produce H2 and CO in a reduction gas to reduce the iron oxide in the shaft furnace. The method also includes, utilizing hydrogen separately provided as a makeup hydrogen, adding the makeup hydrogen to the reduction gas upstream of the reformer, downstream of the reformer, or both. The method additionally includes injecting the reduction gas into the shaft furnace through a bustle gas port. Another element of the method includes removing a top gas from a top gas offtake located above the bustle gas port. The method further includes injecting a part of the makeup hydrogen to the shaft furnace through a makeup hydrogen port located above the bustle gas port and below the top gas offtake such that a reduction speed and a reduction temperature in an upper section of the shaft furnace is moderated.

In at least one embodiment, the method may include adjusting a flow rate of the makeup hydrogen injected into the shaft furnace utilizing a valve and a control unit and based on at least a temperature of the top gas. Additionally or alternatively, the makeup hydrogen port may be located at a level higher than ⅔ of a reduction zone height or higher than 6 m above a reduction gas injection line. In some such embodiments or different embodiments, the reduction zone may be defined as a burden zone between the reduction gas injection level and a controlled feed stock line in the shaft furnace. Additionally or alternatively, the makeup hydrogen may include 90% or more hydrogen gas.

In an additional or alternative aspect, the present subject matter is directed to a method of direct reduction of iron including charging an iron oxide at a top of a shaft furnace. The method further includes reforming natural gas with a reformer to produce H2 and CO in the reduction gas to reduce the iron oxide in the shaft furnace. The method also includes injecting a reduction gas into the shaft furnace through a bustle gas port. The method additionally includes removing a top gas from a top gas offtake located above the bustle gas port. In an additional element, the method includes processing a portion of the top gas in a carbon dioxide removal system to form a carbon dioxide lean gas and a carbon dioxide rich gas. The method also includes injecting carbon dioxide lean gas to the shaft furnace through a carbon dioxide lean gas port located above the bustle gas port and below the top gas offtake such that a reduction speed and a reduction temperature in an upper section of the shaft furnace is moderated.

In at least one embodiment, the method may include adjusting a flow rate of the carbon dioxide lean gas injected into the shaft furnace utilizing a valve and a control unit and based on at least a temperature of the top gas. Additionally or alternatively, the carbon dioxide lean gas may contain between 50% and 70% hydrogen gas. In an additional or alternative embodiment, the carbon dioxide lean gas port may be located at a level higher than ⅔ of a reduction zone height or higher than 6 m above a reduction gas injection line. In some such embodiments or different embodiments, the reduction zone may be defined as a burden zone between the reduction gas injection level and a controlled feed stock line in the shaft furnace.

In an additional or alternative aspect, the present subject matter is directed to a system for the direct reduction of iron and including a shaft furnace. The shaft furnace includes an iron oxide intake located at a top of the shaft furnace and configured to receive an iron oxide. The shaft furnace also includes a bustle gas port configured to inject a reduction gas into the shaft furnace. The shaft furnace further includes a top gas offtake located above the bustle gas port and configured to remove top gas resulting from reduction of the iron oxide. The shaft furnace additionally includes an upper reduction gas port located above the bustle gas port and below the top gas offtake and configured to receive one or more of a hydrogen rich gas, a makeup hydrogen, or a carbon dioxide lean gas. Furthermore, the received hydrogen rich gas, makeup hydrogen, and/or carbon dioxide lean gas may be utilized to moderate a reduction speed, a reduction temperature, or both within an upper section of the shaft furnace.

In at least one embodiment, the system may further include a reformer positioned downstream of the top gas offtake and upstream of the bustle gas port relative to a flow of the top gas. The system may additionally or alternatively include a hydrogen recovery system including a pressure swing absorption gas processing unit, a cryogenic gas processing unit, or both. In some such embodiments or different embodiments, the hydrogen recovery system may be configured to receive a portion of the top gas taken upstream of the reformer and form the hydrogen rich gas and a hydrogen lean gas. Additionally or alternatively, the upper reduction gas port may be configured to receive the hydrogen rich gas processed in the hydrogen recovery system.

In a further or alternative embodiment, the system may include a source of the hydrogen makeup distinct from the top gas. In some such embodiments or different embodiments, the upper reduction gas port may be located to receive the makeup hydrogen.

In an additional or alternative embodiment, the system may include a carbon dioxide recovery system including a pressure swing absorption gas processing unit, an absorption gas processing unit utilizing a solvent, or both. In some such embodiments, the carbon dioxide recovery system may be configured to receive a portion of the top gas taken upstream of the reformer and form the carbon dioxide lean gas. Additionally or alternatively, the upper reduction gas port may be configured to receive the carbon dioxide lean gas processed in the carbon dioxide recovery system.

In an additional or alternative embodiment, the system may further include a valve positioned upstream of the upper reduction gas port relative to a flow of the hydrogen rich gas, the makeup hydrogen, or the CO2 lean gas. Furthermore or alternatively, the valve may be configured to adjust the flow rate of the hydrogen rich gas, the makeup hydrogen, or the CO2 lean gas injected into the shaft furnace through the upper reduction gas port. Additionally or alternatively, the system may include a control unit providing operation control of the valve. In some such embodiments or different embodiments, the control unit may be configured to adjust the flow rate of the hydrogen rich gas, the makeup hydrogen, or the CO2 lean gas injected into the shaft furnace through the upper reduction gas port based on at least a temperature of the top gas.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the accompanying drawings, in which:

FIG. 1 is a process diagram illustrating one exemplary embodiment of a prior art DRI process utilizing a NG reformer, where SF top gas is scrubbed and fed to the reformer after mixing NG and excess scrubbed gas is routed to a top gas fuel line for a reformer burner;

FIG. 2 is a process diagram illustrating one exemplary embodiment of a DRI process with a NG reformer, where SF top gas is scrubbed and fed to the reformer after mixing NG, and part of excess scrubbed gas is routed to an H2 recovery system to recover H2 to feed to the SF upper section to modulate the burden temperature in the SF upper section, in accordance with aspects of the present subject matter;

FIG. 3 is a process diagram illustrating one exemplary embodiment of a prior art DRI process utilizing a NG reformer and top gas CO2 removal, where SF top gas is scrubbed and fed to the reformer after mixing NG, excess scrubbed gas is processed with a CO2 removal system to form CO2 rich gas exported for CO2 sequestration, and CO2 lean gas is partially recycled to the bustle gas with and the remaining CO2 lean gas routed to a top gas fuel line for a reformer burner;

FIG. 4 is a process diagram illustrating one exemplary embodiment of a DRI process with a NG reformer and top gas CO2 removal, where SF top gas is scrubbed and fed to the reformer after mixing NG, excess scrubbed gas is processed with a CO2 removal system to form CO2 rich gas exported for CO2 sequestration, and CO2 lean gas having a higher H2/CO ratio is fed to the SF upper section to modulate the burden temperature in the SF upper section, in accordance with aspects of the present subject matter;

FIG. 5 is a process diagram illustrating one exemplary embodiment of a prior art DRI process utilizing a NG reformer with makeup H2, where SF top gas is scrubbed and fed to the reformer after mixing NG, and the makeup H2 is added to the reduction gas loop before and/or after the NG reformer to flexibly replace a part of NG or H2/CO reformed from NG to reduce CO2 emission; and

FIG. 6 is a process diagram illustrating one exemplary embodiment of a DRI process utilizing a NG reformer with makeup H2, where SF top gas is scrubbed and fed to the reformer after mixing NG. The makeup H2 is added to the SF upper section to modulate the burden temperature in the SF upper section as well as to the reduction gas loop before and/or after reformer to flexibly replace a part of NG or H2/CO reformed from NG to reduce CO2 emission, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “first,” “second,” “third,” and the like may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, in various exemplary embodiments, the present disclosure advantageously provides an improved DR system/method utilizing NG and/or H2 to mitigate iron oxide disintegration during the reduction reaction of the iron oxide in a SF. In embodiments of the improved system and/or method, DR plants have more flexibility for the feedstocks to the SF, such as BF/low grade oxide pellets, lump ores, and CBQ, which tend to disintegrate during the reduction reaction in the SF, as compared with the DR grade oxide pellets commonly used in some DR plants. The ability to use BF/low grade oxide pellets facilitates the DR plant to secure the feedstock with lower cost. The replacement of the indurated pellets with the lump ore and/or CBQ enables the DR plants to reduce the life-cycle CO2 emissions.

Through a series of laboratory tests and observations of DR plant operations with various iron oxide feedstocks, it was found that the fines generation is significantly influenced by the initial reduction speed or temperature. The higher the initial reduction temperature is and/or the higher the initial reduction speed is, the more the iron oxide swells at the initial reduction stage or the reduction degree up to 10~30%. The swelling by the lattice structure as the iron oxide changes from Fe2O3 to Fe3O4 or FeO within the upper section in the SF reduces the physical strength of the iron oxide, which enhances later disintegration as the iron oxide/process iron moves in the moving bed. The reduced physical strength somewhat recovers later as the formation of the metallic iron progresses to sinter and shrink the material, but the strength recovery cannot make up the earlier strength reduction if the swelling exceeds the recovery.

Also, more rapid and more significant swelling sometimes enhances the clustering of the material in the SF since the swelling helps the material to deform in a flat shape and increases the contact area under the burden load in SF. The larger contact area for the deformed iron oxide facilitates the material to stick together and make clusters. Also, the fines generated from the disintegration can also help to make clusters since the fines can bridge the iron oxide. This is the case with lower grade oxide pellets containing less iron that make less recovery and lump ores having no slag or sintering bonding mechanism to prevent the excessive swelling.

Furthermore, this is also an issue especially with CBQ bonded with conventional binders since such binders cannot maintain the physical strength at the initial reduction temperature, typically 400~700° C. in the SF. CBQ tends to disintegrate or make clusters since the bonding strength by the binder is lost when it swells or before the sintering of metallic iron starts. In other words, the swelling with CBQ can be restrained if the temperature is maintained low enough for the binder to keep the bonding strength until the swelling declines or the metallic iron formation starts, preventing or reducing the disintegration or clustering of CBQ in the SF.

Therefore, a key consideration when attempting to reduce or mitigate disintegration and/or the clustering due to the deformation of the iron oxide is to restrain the swelling or initial reduction speed of the iron oxide by modulating the temperature in the upper section in the SF. In the prior art, however, all of the reduction gas injected through the main bustle port located in the lower section of the SF or below the reduction zone flows upward through the iron oxide bed. So, the reducing gas condition in the upper section in the SF is dominated by the reduction gas condition injected through the bustle port to meet the target productivity and product quality and cannot be flexibly changed. Furthermore, the rapid initial reduction of the iron oxide is enhanced within the relatively thinner bed layer below the stock line due to the exothermic reaction from Fe2O3 to Fe3O4 and the efficient heat transfer from the large volume of reduction gas with the higher temperature to the iron oxide fed under the ambient temperature, where the reduction degree and the temperature of the iron oxide quickly ramps up. This helps to maximize the productivity with DR grade oxide pellets but provides disadvantages when processing lower grade oxide or CBQ due to significant fines or clusters formation during the reduction process.

The present disclosure enables modulation (or moderation) of the temperature or flexibly changing the temperature in the upper section in the SF by injecting the H2 or H2 rich gas above the main reduction (or bustle) gas injection ports. The H2 or H2 rich gas injected within the upper section of the shaft furnace lowers the bed temperature due to the significantly more endothermic reaction with H2 as compared to CO or the main reduction gas comprising an H2/CO mixture. The lower exothermic reaction heat from Fe2O3 to Fe3O4 with H2 compared with CO also helps to modulate the speed of reduction and temperature rising to enlarge the initial reduction zone (bed layer just below the stock line) in the upper section of the SF. Simultaneously, as an option, a length of the reduction zone of the SF can be extended in comparison to conventional and prior SFs to offset the initial slower reduction or enlarged the initial reduction zone, so that the productivity can be maintained.

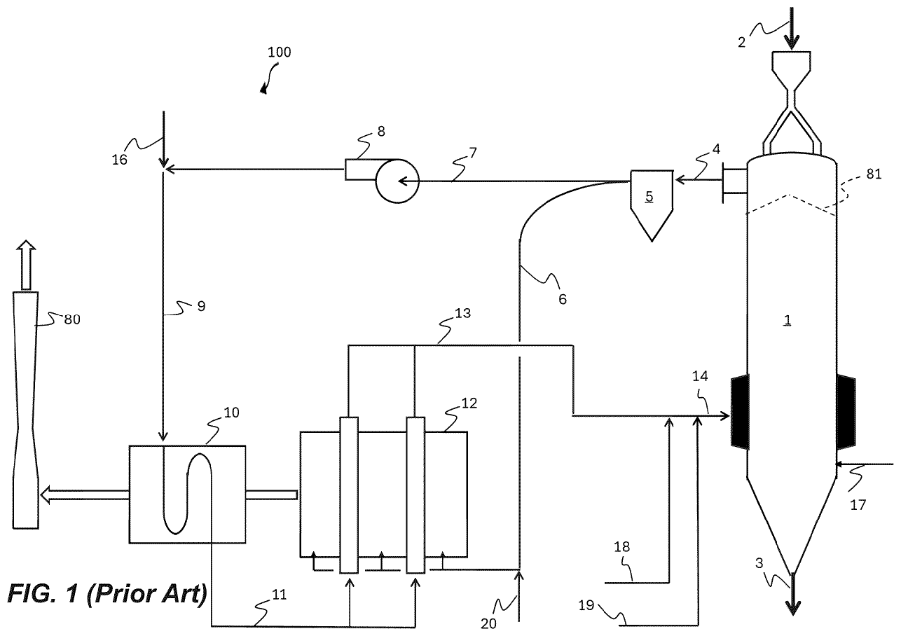

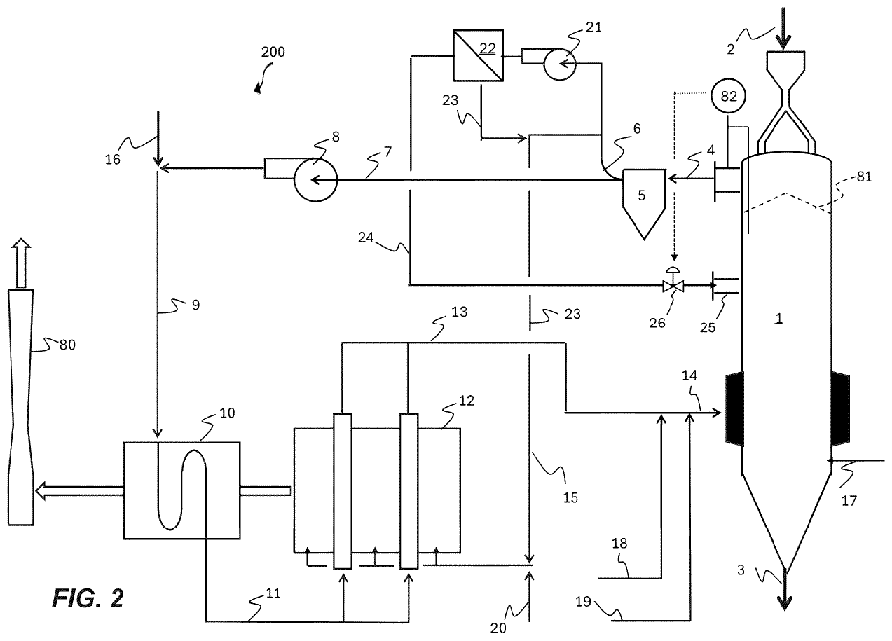

Referring now generally to the drawings, FIGS. 1, 3, and 5 illustrate prior DRI systems and associated processes, and FIGS. 2, 4, and 6 illustrate exemplary embodiments of systems and associated method for the direct reduction of iron overcoming the limitations of the known art (e.g., iron oxide disintegration and/or clustering during direct reduction processes). It will be appreciated that the exemplary direct reduced iron processes and systems depicted and described herein are by way of example only, and, in other exemplary embodiments, the DRI process, system, shaft furnace, plant, or the like may have any other suitable configuration.

One or more of the method elements disclosed herein may be utilized in a suitable process for the direct reduction of iron and incorporated in any suitably configured direct reduction process, system, shaft furnace, or the like. It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently.

FIG. 1 shows a conventional DRI system and associated process/method (system/method 100) with a NG reformer. The SF 1 receives the iron oxide 2 at the top and discharges the product DRI 3 from the bottom. The top gas 4 from the SF 1, which is the spent gas after the reduction of the iron oxide, contains the reaction product, such as H2O and CO2, as well as the unused reductant, such as H2, CO, and CH4. After the top gas 4 is cooled and cleaned with a scrubber 5, most of cleaned process gas 7 is recycled to the SF 1 through the reduction gas loop since it still contains H2 and CO. What is called the top gas fuel 6, which is the excess gas caused by the volume expansion via NG reforming, is removed from the reduction gas loop and combusted as reformer burner fuel with the addition of makeup burner fuel gas 20, as required. Makeup NG 16 is added to the cleaned process gas 7 downstream of a compressor 8, and a mixed gas stream 9 is preheated with a preheater 10. A preheated feed gas 11 is fed to the reformer tubes containing a catalyst in the reformer 12, which enhances the reforming reaction of the methane derived from the NG to produce H2 and CO for the reductant of the iron oxide. Enrichment NG 18 and oxygen 19 are added to the reformed gas 13 to increase CH4 content and temperature, before feeding the bustle gas 14 to the SF 1. Carburizing hydrocarbon gas 17 is injected in a transition zone of the SF 1, which is located below the bustle gas 14 injection level, to carburize the DRI of the SF 1. In various embodiments disclosed herein, the transition zone may be defined as the portion of the SF 1 below injection of the bustle gas 14 and at or above injection of the carburizing hydrocarbon gas 17. All bustle gas 14 injected through the main bustle ports located in the lower section of the SF 1 or below the reduction zone flows upward through the iron oxide bed.

In the conventional systems/methods (e.g., DRI system/method 100), the temperature and gas composition of the top gas 4 or gas within the upper section of the SF 1 are inherently determined by the mass and energy transfer between the bustle gas 14 and the charged iron oxide 2. The reduction speed, temperature, and/or gas quality at the upper section in the SF 1 cannot be independently controlled, other than by the reduction gas 14. For example, the initial reduction speed could be too high as the gas temperature and/or quality gets too high at the upper section in the SF 1 when an excessive flow rate and/or temperature for the bustle gas 14 is applied to bump up the production rate or metallization % for the product DRI 3.

Referring now specifically to FIG. 2, an exemplary embodiment of DRI system and associated process/method (system/method 200) is illustrated in accordance with aspects of the present subject matter. In the illustrated embodiment, the initial reduction speed may be flexibly modulated (or moderated), e.g., by modulating a temperature at an upper section of a SF 1 during reduction of iron oxide 2. Such modulation can be achieved by introducing H2 rich gas 24 to the upper section of the SF 1. Part of a top gas fuel 6 is diverted to an H2 recovery system 22 through the top gas fuel compressor 21. H2 recovery system 22 can be pressure swing absorption unit or system (PSA) or cryogenic gas processing unit or system. H2 rich gas 24 recovered with the H2 recovery system 22 is injected to the SF 1 upper section through an H2 rich gas port 25 at the upper section of the SF 1. H2 lean gas 23 may be mixed with the top gas fuel 6, bypassing the H2 recovery system 22, and may be supplemented with makeup burner fuel gas 20 before being utilized as reformer burner fuel 15 in a reformer 12.

The endothermic reaction between the received iron oxide 2 and the H2 rich gas 24 injected into to the upper section of the SF 24 enables modulation of the temperature or lowering the temperature in the upper section in the SF 1, especially in comparison to process changes related to the reduction gas flowing through SF 1 bed, which is a H2/CO/H2O/CO2/CH4 mixture. The lower exothermic reaction heat from Fe2O3 to Fe3O4 with H2 in comparison with CO also helps to modulate the speed of reduction and temperature in the bed layer just below a stock line 81. The flow rate of the H2 rich gas stream 24 can be adjusted with a suitable valve, flow control valve, or the like (FCV 26) configured to provide a variable and controllable amount of H2 rich gas 24 to flexibly change the temperature in the upper section in the SF 1 referencing a top gas 4 temperature. In some embodiments, the H2 rich gas 24 may include 90% or more hydrogen gas.

As shown, a control unit, control system, controller, or the like (control unit 82) may provide operation control of the FCV 26, thereby allowing for adjustment of the flow rate of the hydrogen rich gas 24 into the upper section of the SF 1 and thus adjustment of the temperature within the upper section of the SF 1. In various embodiments, the temperature of the top gas 4 may be utilized by the control unit 82 as input to determine any changes in the amount of H2 rich gas 24 injected through the H2 rich gas port 25 to maintain a desired temperature or temperature range within the upper section of the SF 1 during use. The control unit 82 may generally include an electronic control unit, multiple associated control units, and/or a combination of one or more processing devices and at least one memory or memory device, as is well known in the art, communicatively coupled to any of the components described herein, e.g., the FCV 26. Any of the process or method elements described herein may be implemented by the control unit 82 utilizing one or more appropriate algorithms. In various embodiments, the control unit 82 may include or be configured as one or more of a distributed control system, a temperature indication and control (TIC) system, an analysis indication and control (AIC) system, combinations thereof, or the like.

Furthermore and in some embodiments, a length of SF 1 may be extended and/or the initial reduction zone of the SF 1 may be enlarged to offset the slower reduction in the upper section of the SF 1 so that the productivity can be maintained.

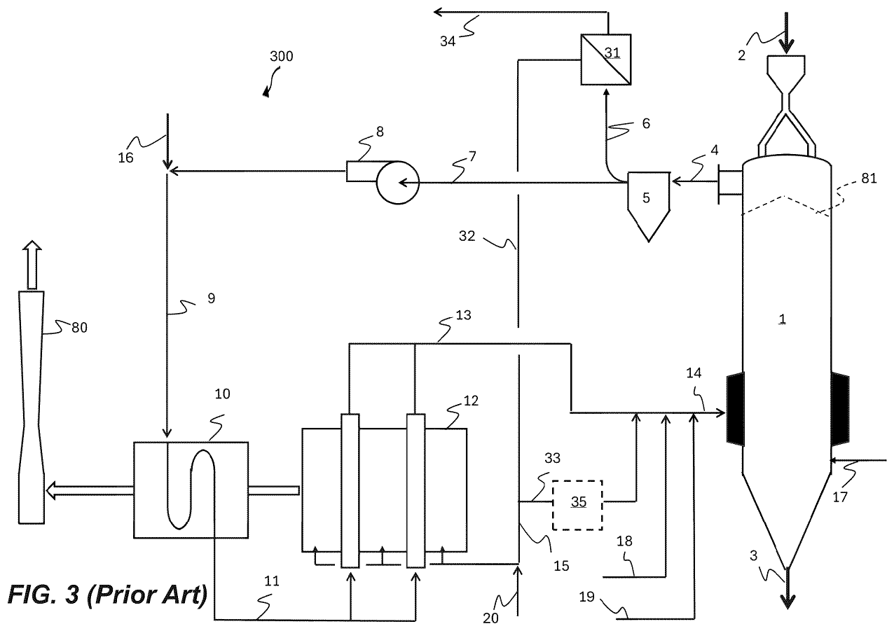

FIG. 3 shows a conventional direct reduction system and associated process/method (system/method 300) with top gas CO2 removal. The system/method 301 may generally be configured similar to the embodiment of system/method 100 described above with respect to FIG. 1. However, a substantial difference with respect to FIG. 1 is to process the top gas fuel 6, which includes around 50% of the total scrubbed top gas, with a CO2 removal system 31, which can be PSA or absorption system with a solvent such as Amine. CO2 rich gas 34 is exported for CO2 sequestration. Around ⅔ of a CO2 lean gas 32 is routed as bustle gas 14 to reduce the iron oxide 2 in the SF 1. As an option, the CO2 lean gas to bustle gas 33 may be heated with the CO2 lean gas heater 35 (depicted in phantom) to minimize the temperature drop of the bustle gas 14 after mixing. The remaining around ⅓ of the CO2 lean gas 15 is routed to the reformer burner as a fuel for the reformer 12 after adding makeup burner fuel gas 20, as required. Reformer 12 reforms CH4 with H2O and CO2 brought from the clean process gas 7 to produce reformed gas 13 with H2/CO=around 1.6. On the other hand, H2/CO for CO2 lean gas to bustle gas 33 is higher because of the lack of CH4 reforming, as only CO2 removal is done for the top gas fuel 6.

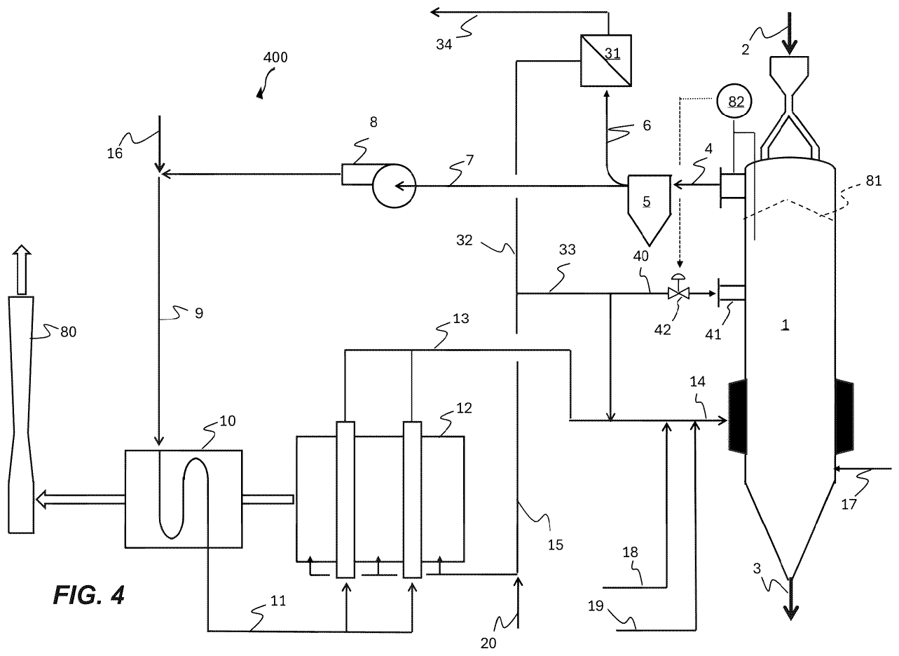

Referring now specifically to FIG. 4, an exemplary embodiment of DRI system and associated process/method (system/method 400) is illustrated in accordance with aspects of the present subject matter. In the illustrated exemplary embodiment, the initial reduction speed may be flexibly modulated (or moderated), e.g., by modulating the temperature at the upper section of the SF 1 during reduction of the iron oxide 2. Such modulation can be achieved by introducing CO2 lean gas 32 to the upper section in the SF 1. As a maximum, ⅔ of the CO2 lean gas 32 (e.g., CO2 lean gas stream 33) can be partially diverted as CO2 lean gas to the upper SF 40 and injected to the SF 1 upper section through a CO2 lean gas port 41 at the upper section of the SF 1.

Due to the higher H2/CO for CO2 lean gas 32 compared to the bustle gas 14 and reduction gas flowing through the SF 1 bed, the injection of CO2 lean gas 40 utilizing the CO2 lean gas port 41 enables modulation and/or reducing of the temperature in the upper section in the SF 1. Such modulation is achieved due to a more endothermic reduction reaction between the iron oxide 2 and H2 in comparison to CO. In some embodiments, the CO2 lean gas 40 and/or CO2 lean gas 32 may include 60% or more hydrogen gas, 30% or less CO gas, and/or 10% or less CH4 gas. Additionally or alternatively, the CO2 lean gas 40 and/or CO2 lean gas 32 may include less than 90% hydrogen gas, such as less than 70% hydrogen gas. Additionally or alternatively, the CO2 lean gas 40 and/or CO2 lean gas 32 may include 50% or more hydrogen gas.

Thus, a flow rate of the CO2 lean gas 40 can be adjusted with a FCV 42 for the CO2 lean gas 40 to flexibly change the temperature in the upper section in the SF 1, which may be at least partially based on or in reference to the top gas 4 temperature. A control unit 82 may provide operational control of the FCV 42 as generally described above referencing FIG. 2 and utilizing a temperature of the top gas 4 as an input parameter, with the caveat that the control unit 82 and FCV 42 may be configured for modulation of the amount of CO2 lean gas to the upper SF 40 and are associated with suitable algorithms configured for such purpose.

Furthermore and in some embodiments, a length of SF 1 may be extended and/or the initial reduction zone of the SF 1 may be enlarged to offset the slower reduction in the upper section of the SF 1 so that the productivity can be maintained.

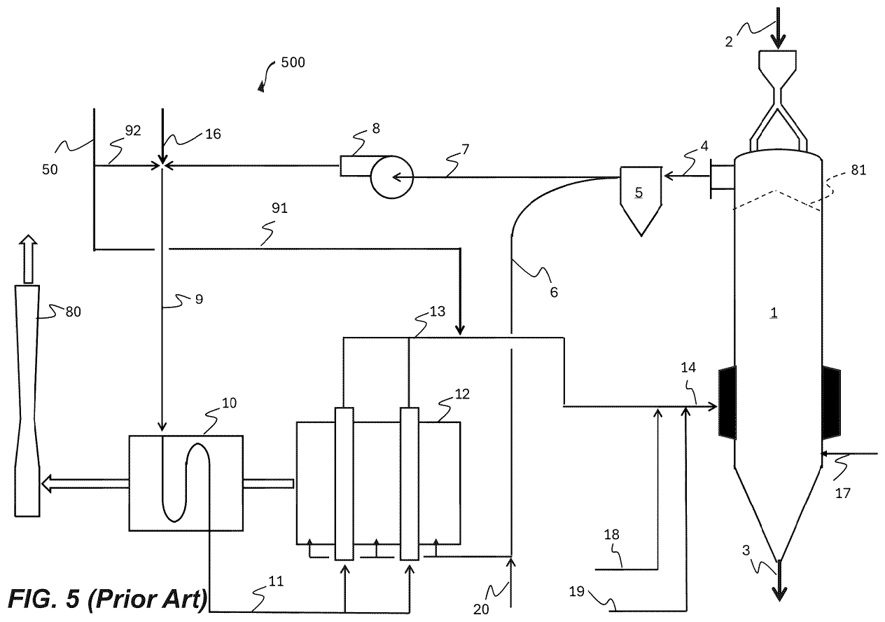

FIG. 5 shows a conventional direct reduction system and associated process/method (system/method 500) with a NG reformer and makeup H2. The system/method 500 may generally be configured similar to the embodiment of system/method 100 described above with respect to FIG. 1. However, a substantial difference with respect to FIG. 1 is to add makeup H2 50 to the reduction gas loop as makeup H2 to process gas 92 and/or makeup H2 gas 91 to reformed gas 13, so that makeup H2 50 will flexibly replace a part of NG makeup 16 or H2/CO reformed from NG with reformer 12 (e.g., reformed gas 13) to reduce CO2 emission from the direct reduction plant, depending on H2 availability. Or, the direct reduction plant with a NG reformer 12 can startup only with NG 16, but later the available amount of makeup H2 16 can be flexibly added to replace makeup NG 16 when H2 becomes available.

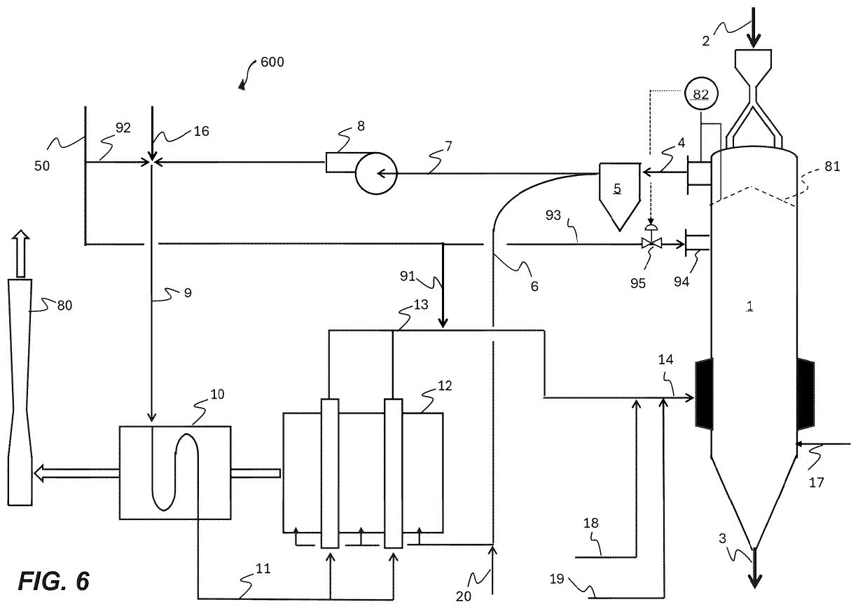

Referring now specifically to FIG. 6, an exemplary embodiment of a DRI system and associated process/method (system/method 600) is illustrated in accordance with aspects of the present subject matter. In the illustrated exemplary embodiment, the initial reduction speed may be flexibly modulated (or moderated), e.g., by modulating the temperature at the upper section of the SF 1 during reduction of the iron oxide 2. Such modulation can be achieved by introducing makeup H2 50 to the upper section in the SF 1, in addition to adding makeup H2 50 to the reduction gas loop as Makeup H2 to process gas 92 and/or Makeup H2 gas 91 to reformed gas 13.

Injecting H2 to the upper section of SF 1 increases the H2 content in the reduction gas flowing through the SF 1 bed, which enables modulation of the temperature or lowering the temperature in the upper section in the SF 1. The makeup H2 50 (e.g., makeup H2 to upper SF 93) is injected into the upper section of SF 1 through makeup H2 port at upper SF 94. A flow rate of makeup H2 to upper SF 93 can be adjusted with an FCV for H2 95 to flexibly change the temperature in the upper section in the SF 1 referencing the top gas 4 temperature. A control unit 82 may provide operational control of the FCV for H2 95 as generally described above referencing FIGS. 2 and 4 and utilizing the temperature of the top gas 4 as an input parameter, with the caveat that the control unit 82 and the FCV for H2 95 may be configured for modulation of the amount of the makeup H2 to upper SF 93 injected through makeup H2 port at upper SF 94 and are associated with suitable algorithms configured for such purpose.

Again, in various exemplary embodiments, the present disclosure advantageously provides an improved DR system/method utilizing NG and/or H2 to mitigate iron oxide disintegration during the reduction reaction of the iron oxide in a SF. In embodiments of the improved system and/or method, DR plants have more flexibility for the feedstocks to the SF, such as BF/low grade oxide pellets, lump ores, and CBQ, which tend to disintegrate during the reduction reaction in the SF, as compared with the DR grade oxide pellets commonly used in some DR plants. The ability to use BF/low grade oxide pellets facilitates the DR plant to secure the feedstock with lower cost. The replacement of the indurated pellets with the lump ore and/or CBQ enables the DR plants to reduce the life-cycle CO2 emissions. For example, swelling with CBQ can be restrained if the temperature is maintained low enough for the binder to keep the bonding strength until the swelling declines or the metallic iron formation starts, preventing or reducing the disintegration or clustering of CBQ in the SF.

The present disclosure enables modulation (or moderation) of the temperature or flexibly changing the temperature in the upper section in the SF by injecting the H2 or H2 rich gas above the main reduction (or bustle) gas injection ports. The H2 or H2 rich gas injected within the upper section of the shaft furnace lowers the bed temperature due to the significantly more endothermic reaction with H2 as compared to CO or the main reduction gas comprising an H2/CO mixture. It should be appreciated that one of the advantages of embodiments the present disclosure is to be able to control the reduction speed or the reduction condition at the upper section in the SF 1 independently from the reduction condition in the lower reduction section of the SF.

The lower exothermic reaction heat from Fe2O3 to Fe3O4 with H2 in comparison with CO also helps to modulate the speed of reduction and temperature rising to enlarge the initial reduction zone (bed layer just below the stock line) in the upper section of the SF. Simultaneously, as an option, a length of the reduction zone of the SF can be extended in comparison to conventional and prior SFs to offset the initial slower reduction or enlarged the initial reduction zone, so that the productivity can be maintained.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the scope of the present disclosure, are contemplated thereby, and are intended to be covered by the following, non-limiting Claims for all purposes.

Component Listing: (one or more of which or similar components may be incorporated in or in association with suitable embodiments of a DRI SF, plant, system, method, or the like).
1 Shaft furnace (SF)
2 Iron oxide feed
3 Direct reduced iron (DRI) product
4 Top gas
5 Scrubber
6 Top gas fuel
7 Cleaned process gas
8 Process gas compressor
9 Feed gas to preheater
10 Preheater
11 Preheated feed gas
12 Reformer
13 Reformed gas
14 Bustle Gas
15 Top gas fuel to reformer burner
16 Makeup NG
17 Carburizing hydrocarbon gas
18 Enrichment NG
19 Oxygen
20 Makeup burner fuel gas
21 Top gas fuel compressor
22 H2 recovery system
23 H2 lean gas
24 H2 rich gas to upper SF
25 H2 rich gas port at upper SF
26 Flow control valve (FCV) for H2 rich gas
31 CO2 removal system
32 CO2 lean gas
33 CO2 lean gas to bustle gas
34 CO2 rich gas
35 CO2 lean gas heater (optional)
40 CO2 lean gas to upper SF
41 CO2 lean gas port at upper SF
42 Fuel gas valve (FCV) for CO2 lean gas
50 Makeup H2
80 Ejector Stack (Stack)
81 Stock Line
82 Control unit or system (Control Unit), e.g., one or more of a distributed control system, a temperature indication and control (TIC) system, an analysis indication and control (AIC) system, combinations thereof, or the like.
91 Makeup H2 to reformed gas
92 Makeup H2 to process gas
93 Makeup H2 to upper SF
94 Makeup H2 port at upper SF
95 FCV for H2
100 DRI system/method in prior art
200 DRI system/method (exemplary embodiment)
300 DRI system/method in prior art
400 DRI system/method (exemplary embodiment)
500 DRI system/method in prior art
600 DRI system/method (exemplary embodiment)

1. A method of direct reduction of iron oxide comprising:
charging an iron oxide at a top of a shaft furnace;
reforming natural gas with a reformer to produce H2 and CO in a reduction gas to reduce the iron oxide in the shaft furnace;
injecting the reduction gas into a shaft furnace through a bustle gas port;
removing a top gas from a top gas offtake located above the bustle gas port;
processing a portion of the top gas in a hydrogen recovery system to form a hydrogen rich gas and a hydrogen lean gas; and
injecting the hydrogen rich gas to the shaft furnace through a hydrogen rich gas port located above the bustle gas port and below the top gas offtake such that a reduction speed and a reduction temperature in an upper section of the shaft furnace is moderated.

2. The method of claim 1, further comprising:
adjusting a flow rate of the hydrogen rich gas injected into the shaft furnace utilizing a valve and a control unit and based on at least a temperature of the top gas.

3. The method of claim 1, wherein the hydrogen rich gas port is located at a level higher than ⅔ of a reduction zone height or higher than 6 m above a reduction gas injection line, wherein the reduction zone is defined as a burden zone between the reduction gas injection level and a controlled feed stock line in the shaft furnace.

4. The method of claim 1, further comprising:
combusting a mixture of the hydrogen lean gas and another portion of the top gas utilizing a reformer burner of a reformer.

5. The method of claim 1, wherein the hydrogen rich gas includes 90% or more hydrogen gas.

6. A method of direct reduction of iron oxide comprising:
charging an iron oxide at a top of a shaft furnace;
reforming natural gas with a reformer to produce H2 and CO in a reduction gas to reduce the iron oxide in the shaft furnace;
utilizing hydrogen separately provided as a makeup hydrogen, adding the makeup hydrogen to the reduction gas at least one of upstream or downstream of the reformer;
injecting the reduction gas into a shaft furnace through a bustle gas port;
removing a top gas from a top gas offtake located above the bustle gas port; and
injecting a part of the makeup hydrogen to the shaft furnace through a makeup hydrogen port located above the bustle gas port and below the top gas offtake such that a reduction speed and a reduction temperature in an upper section of the shaft furnace is moderated.

7. The method of claim 6, further comprising adjusting a flow rate of the makeup hydrogen injected into the shaft furnace utilizing a valve and a control unit and based on at least a temperature of the top gas.

8. The method of claim 6, wherein the makeup hydrogen port is located at a level higher than ⅔ of a reduction zone height or higher than 6 m above a reduction gas injection line, wherein the reduction zone is defined as a burden zone between the reduction gas injection level and a controlled feed stock line in the shaft furnace.

9. The method of claim 6, wherein the makeup hydrogen includes 90% or more hydrogen gas.

10. A method of direct reduction of iron, the method comprising:
charging an iron oxide at a top of a shaft furnace;
reforming natural gas with a reformer to produce H2 and CO in the reduction gas to reduce the iron oxide in the shaft furnace;
injecting a reduction gas into the shaft furnace through a bustle gas port;
removing a top gas from a top gas offtake located above the bustle gas port;
processing a portion of the top gas in a carbon dioxide removal system to form a carbon dioxide lean gas and a carbon dioxide rich gas; and
injecting carbon dioxide lean gas to the shaft furnace through a carbon dioxide lean gas port located above the bustle gas port and below the top gas offtake such that a reduction speed and a reduction temperature in an upper section of the shaft furnace is moderated.

11. The method of claim 10, further comprising:
adjusting a flow rate of the carbon dioxide lean gas injected into the shaft furnace utilizing a valve and a control unit and based on at least a temperature of the top gas.

12. The method of claim 10, wherein the carbon dioxide lean gas contains between 50% and 70% hydrogen gas.

13. The method of claim 10, wherein the carbon dioxide lean gas port is located at a level higher than ⅔ of a reduction zone height or higher than 6 m above a reduction gas injection line, wherein the reduction zone is defined as a burden zone between the reduction gas injection level and a controlled feed stock line in the shaft furnace.

14. A system for the direct reduction of iron, the system comprising:
a shaft furnace comprising:
an iron oxide intake located at a top of the shaft furnace and configured to receive an iron oxide,
a bustle gas port configured to inject a reduction gas into the shaft furnace,
a top gas offtake located above the bustle gas port and configured to remove top gas resulting from reduction of the iron oxide, and
an upper reduction gas port located above the bustle gas port and below the top gas offtake, the upper reduction gas port configured to receive at least one of a hydrogen rich gas, a makeup hydrogen, or a carbon dioxide lean gas, wherein the received at least one of the hydrogen rich gas, the makeup hydrogen, or the carbon dioxide lean gas is utilized to moderate at least one of a reduction speed or a reduction temperature within an upper section of the shaft furnace.

15. The system of claim 14, further comprising:
a reformer positioned downstream of the top gas offtake and upstream of the bustle gas port relative to a flow of the top gas; and
a hydrogen recovery system comprising at least one of a pressure swing absorption gas processing unit or a cryogenic gas processing unit, the hydrogen recovery system configured to receive a portion of the top gas taken upstream of the reformer and form the hydrogen rich gas and a hydrogen lean gas,
wherein the upper reduction gas port is configured to receive the hydrogen rich gas processed in the hydrogen recovery system.

16. The system of claim 14, further comprising:
a reformer positioned downstream of the top gas offtake and upstream of the bustle gas port relative to the flow of the top gas; and
a source of the hydrogen makeup distinct from the top gas,
wherein the upper reduction gas port is located to receive the makeup hydrogen.

17. The system of claim 14, further comprising:
a reformer positioned downstream of the top gas offtake and upstream of the bustle gas port relative to the flow of the top gas; and
a carbon dioxide recovery system comprising at least one of a pressure swing absorption gas processing unit or an absorption gas processing unit utilizing a solvent, the carbon dioxide recovery system configured receive a portion of the top gas taken upstream of the reformer and form the carbon dioxide lean gas,
wherein the upper reduction gas port is configured to receive the carbon dioxide lean gas processed in the carbon dioxide recovery system.

18. The system of claim 15, further comprising:
a valve positioned upstream of the upper reduction gas port relative to a flow of the hydrogen rich gas, the valve configured to adjust the flow rate of the hydrogen rich gas injected into the shaft furnace through the upper reduction gas port; and
a control unit providing operation control of the valve, the control unit configured to adjust the flow rate of the hydrogen rich gas injected into the shaft furnace through the upper reduction gas port based on at least a temperature of the top gas.

19. The system of claim 16, further comprising:
a valve positioned upstream of the upper reduction gas port relative to a flow of the makeup hydrogen, the valve configured to adjust the flow rate of the makeup hydrogen injected into the shaft furnace through the upper reduction gas port; and
a control unit providing operation control of the valve, the control unit configured to adjust the flow rate of the makeup hydrogen injected into the shaft furnace through the upper reduction gas port based on at least a temperature of the top gas.

20. The system of claim 17, further comprising:
a valve positioned upstream of the upper reduction gas port relative to a flow of the CO2 lean gas, the valve configured to adjust the flow rate of the CO2 lean gas injected into the shaft furnace through the upper reduction gas port; and
a control unit providing operation control of the valve, the control unit configured to adjust the flow rate of the CO2 lean gas injected into the shaft furnace through the upper reduction gas port based on at least a temperature of the top gas.
